(19) United States
(12) Patent Application Publication
(10) Pub. No.: US 2016/0035028 A1
(43) Pub. Date: Feb. 4, 2016

(54) Method For Facilitating Futures Trading Of Synthetic Benchmark Corporate Bonds

(71) Applicant: Robert HEDGES, Westport, CT (US)

(72) Inventor: Robert Hedges, Westport, CT (US)

(21) Appl. No.: 14/775,314

(22) PCT Filed: Feb. 28, 2014
(86) PCT No.: PCT/US14/19458

§ 371 Date: Sep. 11, 2015

Related U.S. Application Data
(60) Provisional application No. 61/781,489, filed on Mar. 14, 2013.

(51) Int. Cl. G06Q 40/04

(52) U.S. Cl. CPC G06Q 40/04

(57) ABSTRACT

A method of creating and trading on an exchange a futures contract linked to the yield of synthetic corporate debt instruments. The terms of the contract are such that it provides for a cash payment from one party to another based on the yield of a synthetically created corporate bond benchmark upon expiration of the futures contract. The synthetic corporate bond benchmark terms may include a combination of yield, credit rating, maturity, industry, currency or some other economically significant variable such terms being defined prior to the standardized contract being available for trading. Corporate synthetic benchmarks are valued by assigning traded corporate debt securities to the defined risk category and calculating the resultant yield. The contract may also reference two or more synthetic benchmarks.

### CROSS REFERENCE TO RELATED APPLICATIONS

This application claims the benefit of priority from U.S. Provisional Patent Application No. 61/781,489 that was filed on Mar. 14, 2013, the entirety of which is hereby incorporated herein by reference.

### FIELD OF THE INVENTION

This invention relates to a computerized method for facilitating the trading of a future linked to the yield of at least one synthetic corporate bond benchmark.

### BACKGROUND OF THE INVENTION

There are a wide variety of financial derivatives currently available in market. One type of derivative is a financial futures contract. Futures contracts derive their value in part from the value or characteristic of some other underlying asset. The underlying asset may include securities such as stocks, commodities, market indicators or indexes, interest rates, and government bonds, to name but a few of the most common assets.

In a futures contract a buyer purchases the right to receive delivery of an underlying commodity or asset on a specified date in the future. Conversely, a seller agrees to deliver the commodity or asset to an agreed location on the specified date. Futures contracts originally developed in the trade of agricultural commodities, but quickly spread to other commodities as well and today the majority of futures trading is in financial futures. Because futures contracts establish a price for the underlying commodity in advance of the date on which the commodity must be delivered, subsequent changes in the price of the underlying asset will inure to the benefit of one party and to the detriment of the other. If the price rises above the futures price, the seller is obligated to deliver the commodity at the lower agreed upon price. The buyer may then resell the received product at the higher market price to realize a profit. The seller in effect loses the difference between the futures contract price and the market price on the date the goods are delivered. Conversely if the price of the underlying commodity falls below the futures price, the seller can obtain the commodity at the lower market price for delivery to the buyer while retaining the higher futures price. In this case the seller realizes a profit in the amount of the difference between the current market price on the delivery date and the futures contract price. The buyer realizes an equivalent loss.

Futures contracts may be settled in cash. Rather than actually delivering the underlying asset, cash settlement merely requires payment of the difference between the market price of the underlying commodity or asset on the delivery date and the price at which the futures contract trade was executed. The difference between the market price and the futures price is to be paid by the short investor to the long investor, or by the long investor to the short investor, depending on which direction the market price has moved. Cash settlement provides great flexibility regarding the types of underlying assets that derivative investment instruments may be built around. Essentially any variable whose value is subject to change over time, may serve as the underlying asset for a derivative investment instrument.

Corporate bonds form part of the financing sources for modern companies, together with equity, bank loans, and structured financing products. The value of a security such as a corporate bond is based on its face value, the maturity date of the bond, coupon rate and frequency of coupon payments, and the creditworthiness of the issuer. A coupon payment on a corporate bond is a periodic interest payment that the bondholder receives during the time from bond issuance to maturity.

For example a 6% coupon for a bond with a notional value of one million US dollars would result in a payment amount of approximately (0.06)×(1,000,000) or $60,000, or a semi-annual payment of approximately $30,000 depending on the payment frequency and the day count basis of the interest payments. The amount that a buyer pays for such a bond depends on the yield at which it is offered. If the yield is below the coupon amount the bond will trade at a price greater than 100 (par) and vice versa. The yield is set by supply and demand but is typically set as a spread to the risk free US government bond yield. This spread fluctuates depending on many factors but primarily it reflects the additional credit risk of the corporation issuing the bond and tends to increase as the risk of default increases and or the maturity date of the bond. Rating agencies such as Moody's Investor Services, S&P and Fitch seek to quantify this risk of default by issuing credit rating schedules. The rating schemes followed by the three major rating services are all similar. Each includes multiple levels, with each level representing a different level of risk, or a different ranking of the perceived ability of a rated entity to meet its debt obligations. A 1 to 3-letter code identifies each of the different levels. For example Moody's defines nine primary risk levels: Aaa, Aa, A, Baa, Ba, B, Caa, Ca, and C. According to this system, the Aaa rating is reserved for the entities that demonstrate the strongest credit worthiness while those rated C demonstrate the weakest credit. There may also be a smaller additional risk premiums one example being an increase in yield if the bond is very illiquid.

According to the Securities Industry and Financials Markets Association (SIFMA) the size of the US corporate bond market in Q3 2012 was $8.6 trillion. SIFMA have recently reported quarterly traded volumes to be in the region of $21.1 billion per day in February 2013 with just 46,696 trades daily on average, and while some estimates place the number of corporate bond issues at around 40,000, TRACE reports about 6,500 issues trading per day. In contrast the US equity market has approximately 6,500 listings, daily volume in the region of $112 billion, 25 million trades and a market cap of $17 trillion. The Department of the Treasury, Office of Debt Management Fiscal Year 2012 Q2 Report cites that trading in 37 credits accounted for 50% of the trading volume in the corporate bond market. Clearly, the liquidity available with respect to equities is not available to a market participant wishing to buy or sell a corporate bond.

Unlike the equity market one corporation may issue several bonds but will typically have one major equity listing, this phenomena leads to sharply lower liquidity in the corporate bond market and wide bid offer spreads. The Department of the Treasury, Office of Debt Management Fiscal Year 2012 Q2 Report cites the average bid/offer spread on an Investment Grade bond was about 13 basis points in September 2011 and estimated that the transactional costs of trades can comprise 5% of the total security yield.

The majority of corporate bonds trade in the over the counter (OTC) market where prices and liquidity have traditionally been supplied by Wall Street Investment Banks. However recent changes in banks capital requirements and regulatory changes such as Dodd-Frank incorporating the ‘Volcker Rule’ restrictions on proprietary trading have required investment banks to drastically cut their inventory of corporate bonds. The Department of the Treasury, Office of Debt Management Fiscal Year 2012 Q2 Report states that dealer inventory has declined by more than 70% at a time when the total corporate bond issuance has been growing. As a result liquidity in the corporate bond market is provided by new dealers outside of investment banking institutions. The dealers provide electronic bids and offers to electronic bond trading platforms. These new dealers lack the financial resources of the investment banks and would benefit enormously from the existence of a liquid hedging instrument.

Investors generally consider factors such as credit markets as a whole, for example, that a change in economic activity or interest rates will cause corporate bonds to underperform versus government debt, or that one credit sector will outperform another. However trading based on these criteria in today's markets is costly if not impossible given the fragmented liquidity, wide bid/offer spreads and lack of availability of any liquid benchmark instruments.

Credit Default Swaps have been proposed as a solution to this dilemma. However, the complexity of this financial instrument and the present state of flux between OTC trading to exchange trading and clearing may make trading corporate bonds based on the Credit Default Swaps an undesirable option for the average investor or market maker in corporate bonds.

There are two principal designs of bond futures contracts in use today, a) contracts that require physical delivery of bonds on expiry of the contract, such as the contract on US treasury notes traded on the CME, and similar contracts on other government bonds traded at LIFFE (UK), EUREX (Frankfurt), TSE (Tokyo) and b) cash settled contracts the sole example of which is traded on the ASX (Sydney) linked to Australian Government Bonds. The complexity of the pricing and delivery mechanisms makes these types of contracts unsuitable for adaptation to corporate bonds for which no contracts are traded today.

The physical delivery model defines a basket of bonds at the time listing of the contract that can be used to satisfy the seller's obligation. Usually there is one bond that is the cheapest to deliver at expiry (CTD) for the seller and delivery activity is concentrated around the issue of this cheaper bond. The existence of a CTD bond can lead to situations where speculators try to create a shortage of the CTD to force the seller to deliver more expensive bonds and thus reap a higher profit. This speculation in government bonds has been observed in the United States treasury market, one of the most liquid government bond markets in the world.

Clearly, such a physical delivery model for corporate bonds would be fraught with difficulties in view of the illiquid corporate bond markets. An additional level of complexity to consider when studying the possibility of applying this model to the corporate bond market is that the credit risk on the existing contracts comprises of one homogenous credit i.e., one government risk. Applying CTD futures to the corporate bond market and a basket of several credits could result in the distortion of the market not just for one bond but for one corporation thus having some severe repercussions for the borrowing costs of that one corporation as well as other corporations.

The cash settled government bond contract traded on the ASX is linked to a basket of three or four Australian Government bonds selected by the exchange prior to the time of listing. There is no physical delivery. The exchange has a sophisticated method of determining the final futures settlement yield by calling dealers at three intervals and after discarding outlier quotes will calculate the average quoted yields for cash bonds. The ASX contract is quoted and traded in terms of yield (100−yield). For purposes of settlement, including the final settlement, the yield is converted into a bond price. While trading differently from the US government bonds contract, the contract actually settles in a similar manner, on price. This cash settlement methodology avoids the complexities of the cheapest to deliver as seen in the US government bond contracts. However, the calculations of settlement prices and trading revenues remains complex and the value or a price move is variable depending on the yield traded.

### SUMMARY OF THE INVENTION

In view of recent changes with respect to the ability of investment bankers to trade corporate bonds and the lack of liquidity of the corporate bond market, there is a need to develop a computerized method which facilitates cash corporate bond trading by offering a liquid method of hedging by providing the trading of futures contracts linked to synthetic corporate bond benchmark yields. Preferred embodiments of the invention provide a computerized method that facilitates the trading of a future linked to the yield of at least one synthetic corporate bond benchmark.

In a computerized method for facilitating the trading of a future linked to at least one synthetic corporate bond benchmark yield in accordance with the invention a series of futures contracts is listed on an electronic exchange platform. The futures contract includes terms that require settlement in cash upon expiry of the contract on the specified date based on at least one synthetic corporate bond benchmark yield. An electronic exchange platform, or a computer receives one or more orders to buy or sell a futures contract. An order book of such orders to buy or sell futures contracts is built via a computer process and the orders are matched according to pre-defined matching rules. An order to buy or sell the futures contract linked to at least one synthetic corporate bond benchmark yield is executed. Pricing information including unattributed pricing data of the futures contracts, i.e., prices and quantities in the book and executed trades are disseminated to market participants and executed trade data is electronically transmitted to a clearing house. A synthetic corporate bond benchmark yield determined by the reference data source is electronically transmitted to the electronic exchange platform and market participants

In one embodiment the synthetic corporate bond benchmark is defined by a combination of as many or as few of the following attributes as is desirable at the listing of the contract before trading commences: Maturity (tenor), credit rating, industry, currency, country of domicile or other such terms that represent economic value.

### BRIEF DESCRIPTION OF THE DRAWINGS

To provide a more complete understanding of the present invention and features and advantages thereof, there is illustrated in the accompanying diagrams an embodiment thereof, which when considered in connection with the following description, many of its advantages should be readily understood and appreciated.

FIG. 1 depicts an overview of a simplified block diagram illustrating a schematic of a system for facilitating the trading of a synthetic corporate bond benchmark futures contract in accordance with an embodiment of the present invention;

FIG. 2 depicts a diagram illustrating an example of a synthetic corporate bond benchmark futures contract that may be traded on the system illustrated in FIG. 1 in accordance with an embodiment of the present invention;

FIG. 3 depicts a diagram illustrating an example of a synthetic corporate bond benchmark futures spread contract that may be traded on the system illustrated in FIG. 1 in accordance with an embodiment of the present invention;

FIG. 4 depicts a diagram illustrating an example of hedging ratios of cash corporate bonds with an embodiment of the futures contract, and an illustration of the rate of change of the value of a basis point in yield; and

FIG. 5 depicts an overview of a simplified flowchart illustrating a series of example steps with a method which may be taken by an exchange providing a futures contract in FIGS. 2 and 3 using the system illustrated in FIG. 1.

### DETAILED DESCRIPTION OF THE INVENTION

The method of the invention provides that a futures contract which relates only to corporate bonds is settled upon expiry with reference to a published yield for a synthetic corporate bond benchmark, within a defined industry, maturity, credit rating, currency or country of domicile or a combination of any of these features or other features having an economic impact. Linking the future to a synthetic security and cash settling on the same avoids the complexities of the physical delivery model and may facilitate liquidity in the corporate bond cash markets without introducing potentially harmful Cheapest to Deliver and associated potential manipulative practices and pressures.

The futures contract will have a fixed dollar value for every incremental change in yield thus avoiding the complexities of existing bond contracts with respect to yield and price conversion observed in present contracts.

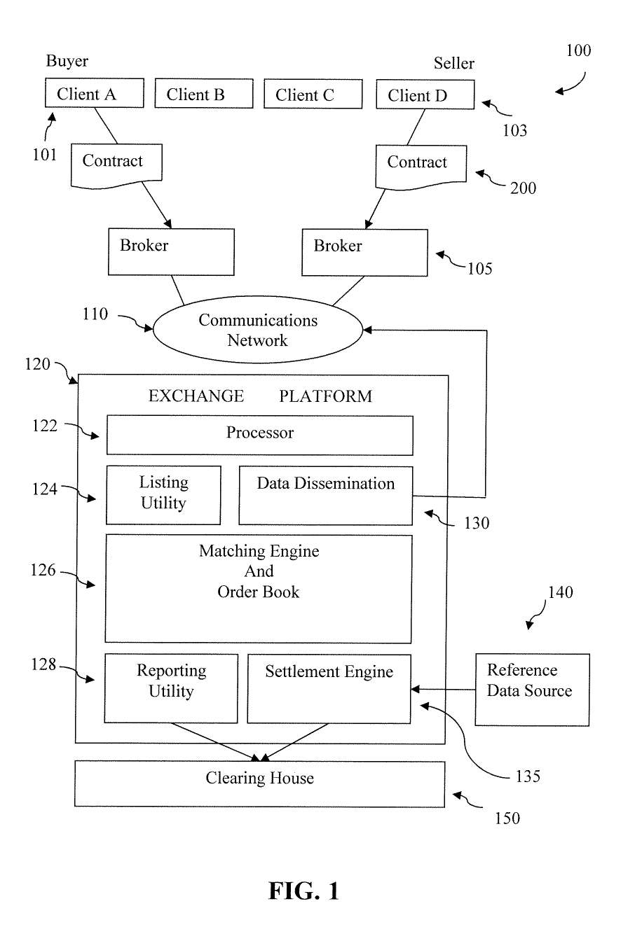

Features of some embodiments of the invention will now be described by first referring to FIG. 1. FIG. 1 depicts an overview of a simplified block diagram illustrating a schematic of a system 100 for facilitating trading of the futures contract 200. The system 100 comprises; a buyer 101, a seller 103, a broker 105, communications network 110, an exchange platform 120, a reference data source 140 and a clearing house 150. The exchange platform 120 may include a processor 122, a listing utility 124, a matching engine and order book 126, a reporting utility 128, a market data dissemination utility 130 and a settlement calculation engine 135. The exchange platform 120 may be coupled to a clearing house 150.

The exchange platform 120 is a trading architecture that facilitates the purchase and sale of one or more futures contracts 200. The exchange platform is operable to receive and process requests relating to trading orders in the futures contract 200. The exchange platform 120 may be owned and operated by a suitable entity having the authority to operate a futures exchange and will be comprised of one or more computers operated by that entity. The exchange platform may operate generally along conventional practices, except for the embodiments disclosed herein and may list and facilitate trading in other futures and options contracts in addition to the novel contracts described herein. As will be appreciated by those who are skilled in the art, the futures trading exchange 120 may perform functions normally performed by a trading exchange, such as listing contracts for trading, receiving and matching orders to buy and sell the listed contracts, providing current quotations and reports concerning open orders and trading activity on the exchange 120.

Clients 101 and 103 wishing to buy and sell the futures contract 200 will maintain accounts with brokers 105 who are exchange members, clients 101/103 will electronically transmit orders to their broker 105 for onward transmission to the exchange platform 120 via the communications network 110. In addition or alternatively the brokers/trading firms 105 may place orders for their own account with the futures trading exchange 120.

The communications network 110 is a communicative platform operable to exchange data or information between buyer 101, the seller 103, the brokers 105 and exchange platform 120. In one embodiment of the invention the communications network 110 represents an Internet based architecture. Alternatively, it could be any communications network which buyer 101, Seller 103 or brokers 105 could use to perform the same operations or functions. In other embodiments, communications system 110 could be any packet data network (PDN) offering a communications interface or exchange between any two nodes in the system 100. Communications network 110 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment.

The end user interface employed by either buyer 101, seller 103 or broker 105 in order to initiate transactions or to perform monitoring functions within system 100 may be the users proprietary software, or broker or third party vendor provided software and could be software presently used to facilitate trading in existing futures contracts modified where necessary to facilitate the futures contract 200. Alternatively, such an end user interface may be replaced with any other suitable interface or object that facilitates communications between buyer 101, seller 103, broker 105, and any other element within system 100, such as: a cellular telephone, a laptop, a smartphone, touchpad, or any other suitable device (wireless or otherwise), component, or element capable of accessing one or more elements within system 100. The end user interface may also comprise any suitable interface for a human user such as a display, a microphone, a keyboard, or any other appropriate terminal equipment according to particular configurations and arrangements.

The exchange platform 120 may comprise of any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. In some embodiments the hardware aspects of this system component may be entirely conventional.

The exchange platform 120 comprises of one or more programs (at least some of which being shown by blocks 124-135) for controlling processor 122. Processor 122 performs instructions of the programs, and thereby operates the exchange platform 120 in accordance with the present invention. The listing utility 124 is able to list one or more futures contracts 200 for trading by the exchange platform 120.

Another program, the matching engine/order book 126 allows the exchange platform 120 to receive and process incoming instructions including orders to buy and sell futures contracts 200, to match offsetting orders in accordance with the exchange matching engine rules and maintain a book of pending orders after being properly managed and secured by processor 122. The matching engine 126 may operate in accordance with conventional practices.

Another program, the reporting utility portrayed by block 128 provides reports of activity on the exchange platform 120 allows for orderly settlement of trades executed on the exchange platform 120, and also provides reports as needed for compliance with regulatory requirements.

Exchange platform 120 may also deliver real-time data to market participants and market data vendors, the data dissemination utility 130 handles this function. The data dissemination utility 130 may disseminate pertinent information such as the time, quantity of contracts and price of executed trades, outstanding bids and offers i.e. the current state of the order book to be used by market participants and cash corporate bond traders to make decisions as to whether to purchase or to sell futures contract 200. It may also disseminate data, such as contract information, contract spread information e.g. the difference between two or more futures contracts, settlement prices, historical quotes, or moving averages. Where possible this program will operate along conventional lines in order to facilitate integration into present trading interfaces. The potential integration of this data into dealers electronic pricing and quoting engines for cash bonds is important to facilitate the use of futures contract 200 as a reference mechanism enabling greater liquidity in the cash bond markets.

The settlement method 224 at expiry of the futures contract 200 is set by use of the yield of the synthetic corporate bond benchmark 201 according to the reference data source 140. In one embodiment of the invention this source may be the Bloomberg Valuation Service. The settlement calculation engine 130 maps the reference data source to the appropriate futures contract 200 and in accordance with the settlement method 224 calculates the final settlement value of trades as the difference between the traded price and the settlement price adjusted for the tick value and number of contracts traded.

Another component of the system 100 is a clearing house 150. The clearing house 150 acts as counterparty with respect to all traders or investors who buy or sell the futures contract 200 in the traditional manner.

Another component of the system 100 is a reference data source 140. The reference data source 140 may provide data to either or both of the exchange platform 120 and the clearing house 150. For example, a potential source of a yield for a synthetic corporate bond benchmark 201 may be obtained from the “Bloomberg Valuation Service (BVAL)” who provides such data on a daily basis. Bloomberg Valuation Service calculates the yields of these synthetic corporate bond benchmarks 201 by reference to the observed trading activity in relevant individual corporate cash bonds using a sophisticated proprietary algorithm that weights bonds by liquidity, excludes outliers caused by technical trading factors and excludes certain bond structures. Bloomberg publishes more than 50 investment grade sector curves across various rating levels each of which is constructed by calculating points for various tenors or maturities. Bloomberg weights the observed trading activity in an individual corporate bond in the basket of corporate bonds by the tenor to calculate a theoretical yield for a synthetic corporate bond benchmark of a fixed tenor assuming that bond were issued today. For example, the yield of a corporate bond with a maturity of 10.5 years would be given a higher weight than the yield of a bond with an 8 year maturity if one were calculating the yield of a synthetic 10 year bond in the Bloomberg calculation. Based on these calculations Bloomberg determines a yield for a new synthetic bond based on the yields of a basket of selected corporate bonds.

Any suitable reference benchmark yield based on calculating the yield of a synthetic corporate bond benchmark may be used in the invention provided that the calculation is based upon observed underlying activity in the corporate cash bond market and therefore is a good representation of the true underlying market, thus linking the futures contract to observable activity in cash markets. The tie to actual published rates reflective of the cash market is very important for two reasons a) to avoid arbitrary rate setting as was reported recently with respect to LIBOR rates, and b) to avoid the necessity of physical delivery with all the complications and weaknesses associated with CTD mechanisms discussed above.

Importantly, the recently implemented FINMA TRACE reporting requirement for corporate bond trades provides the transparency required to calculate a benchmark yield with some accuracy. The TRACE reporting requirement requires that trades in corporate bonds are reported to a central authority within 15 minutes of execution. This is a stringent regulatory requirement. Trades are published and generally publicly available.

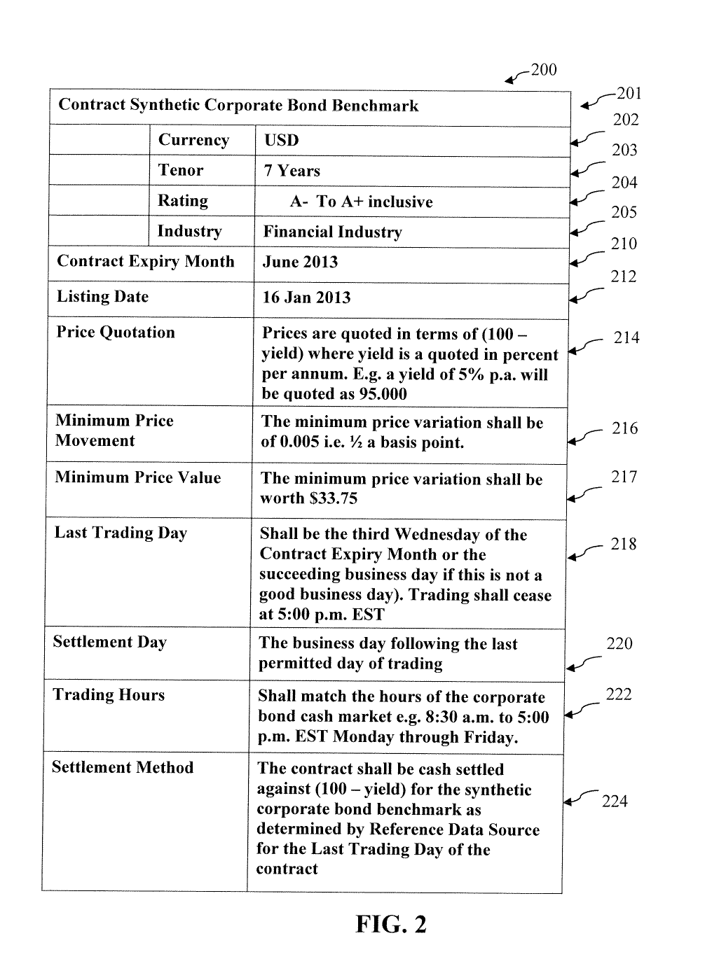

FIG. 2 depicts an overview of one embodiment of a corporate bond future and blocks 201 through 205 demonstrate how a synthetic corporate bond benchmark 201 may be defined given a set of desirable economic variables to be reflected in the value of the futures contract 200. The yield of the synthetic corporate bond benchmark 201 will be calculated by the reference data source 140 using cash bonds that have been mapped by the reference data source 140 to the criteria provided that they meet the proprietary standards set for inclusion in the calculation as discussed above. The synthetic corporate bond benchmark 201 criteria may be selected by reference to whether the criteria would capture a wide enough pool of cash bonds for calculation of a yield for the synthetic corporate bond benchmark 201. For example, were there only a small number of corporate bonds issued by corporations mapped to the industry Financials Consumer Credit then this industry may be subsumed into the broader industry of Financials. The currency 201 maybe set as any currency in which underlying cash corporate bonds are issued. The Tenor 203 in one embodiment may be 5 years, 7 years, 10 years and 30 years with other tenors being made available if required. The credit rating 204 in one embodiment refers to values assigned to a corporate bond by one of Moody's Investor Services, Standard and Poor's or Fitch. The industry 205 definitions available for use in the contract 200 may be determined by the reference data source 140 as described above and in one embodiment these may represent the industries used by FINMA in TRACE reporting.

The futures contract expiry months 210 in one embodiment will be quarterly and defined as March, June, September and December in line with a well-established practice in the financial futures market. In another embodiment there will be two expiries listed at any one time for each contract synthetic corporate bond benchmark 201. The contract listing date 212 is the first date that the futures contract 200 is available for trading on the system 100.

The futures contract 200, in accordance with the invention, will provide for price quotation 214, the daily settlement price and the settlement method 224 to be in terms of yield to maturity on a percent per annum basis, quoted on the basis of (100−yield), e.g. a bid at a yield of 4.95% shall be entered into the system 100 at a price of 95.05. In one embodiment the minimum price movement 216 shall be quoted in 0.005 increments or one half of a basis point, e.g. if another buyer 101 wished to enter a better bid than the existing bid of 4.95% the next permissible price would be 95.055 representing a yield of 4.945%. In other embodiments futures contract 200 may set the minimum price movement 216 in smaller increments. Each minimum price increment 216 will represent a pre-determined currency amount fixed for the life of the futures contract 200 this is known as the minimum price value 217.

The minimum price value 217 set prior to the listing of the contract remains constant throughout the life of the futures contract 200 irrespective of the yield/price levels quoted or traded. This simplification greatly assists the speed of trading decisions, there being no conversion price/yield calculations to be effected and no cheapest to deliver security to track. By setting the minimum price increment value to a constant for each contract it becomes very simple to move exposure from one industry to another by simply buying one contract and selling the other. In one embodiment the last trading day 218 may be set as the third Wednesday of the expiry month, providing that this is a good business day for trading cash corporate bonds. In such embodiment, trading shall cease at 5 μm EST in the US or 5 μm local time for the relevant currency 201, or whatever time the cash corporate bond market closes on the last trading day 218. Daily trading hours 222 for the futures contract 200 on the exchange platform 120 may match the trading hours of the underlying cash corporate bond market, with such trading hours 222 being established and published prior to the listing date 212.

The settlement date 220 shall be the next available business day following the last trading day 218 in the currency 202 in which the futures contract 200 is denominated. Settlement will be effected by a cash payment or receipt to or from the clearing house 150 as calculated in accordance with the settlement method 224 as the difference between the trade price and the synthetic corporate bond benchmark supplied by the reference rate source 140 multiplied by the number of contracts traded. This settlement methodology simplifies settlement value determination in that does not require any conversions of yield to bond price, accrued interest considerations or cheapest to deliver conversion factors.

The advantages accruing to participants in the corporate bond market, whether dealers or investors by the availability of the futures contract 200 facilitated by the system 100 may be better understood by considering the following examples. The advantages or the futures contract are in no way limited to the instances described, which are stated here merely for the purposes of illustration on how the futures contract 200 may be used for practical benefit by participants in the corporate bond market.

### Example 1

Corporate bond yields are typically composed of two main components, the risk free rate which is the rate at which US treasuries trade plus a credit spread which is the risk premium that an investor receives for lending to a credit other than the US government. This credit premium may increase as the risk of default increases. There may also be additional smaller premiums one example being an increase in yield if the bond is very illiquid. The futures contract 200 seeks to allow a participant in the corporate bond market to hedge a cash bond position against a general industry wide move in the credit spread relative to the risk free rate. An example of how the futures contract 200 may effect this is described below.

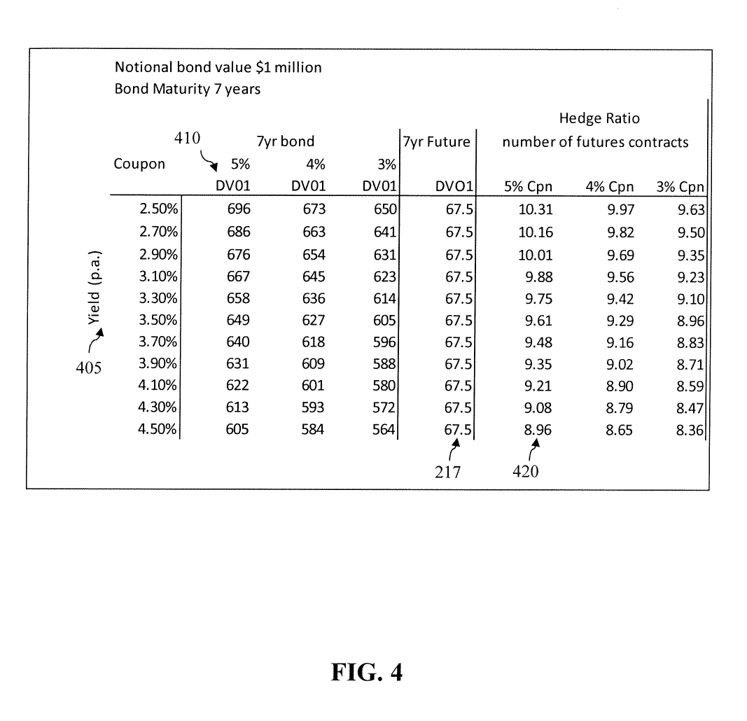

An bondholder owns a corporate bond with a nominal value of one million US dollars issued by XYZ automobile corporation, the bond having a credit rating ‘A’, a 7 year maturity, and a semi-annual coupon of 5.00% The bond last traded at a price of 118.12% implying a yield to maturity of 2.9% per annum (p.a) using standard calculation methodologies. The bond has a dollar value (DV01) of $676 which means that a one basis point increase in yield will change the value of the bond by $676. As shown in FIG. 4, the value of a basis point change is not a constant and will change with a change in yield. The basis point value also changes with time as the tenor of the bond shortens.

The bondholder believes that there will be negative economic news that will affect all corporations in the industry to which his/her bond issuer belongs. An example of such news maybe that demand for new cars is going to fall due to tighter credit criteria and therefore car companies are going to be less profitable and possibly incur losses which in turn will increase risk premiums (spreads) for the bonds. It is the view of the bondholder that yields will rise by at least 40 basis points.

In the absence of the present invention, the bondholder has four choices:
Sell the bond and buy it back later. As the bid/offer spread on corporate bonds may be 10 basis points even for more liquid issues this is an expensive option. If the bond is less liquid the bondholder may not be able to locate a buyer at all.
Hold the bond and accept the loss.
Sell another similar bond on which there is an advantageous bid and will change value approximately in line with the present holding, then reverse the position later once the expected spread move has occurred. The bondholder will of course need to borrow the bond in the repo market, which may be difficult, and of course the bid offer spread may have to be crossed to buy back the bond sold such that the bondholder is back to option one.
Sell US treasuries. This option will not work as the risk the bondholder anticipates is a shift in credit spreads due to an economic change and a scenario where corporate bonds underperform US treasuries.

Invariably, in the absence of the present invention, the bondholder will take no action. The corporate bond markets will continue to be illiquid and the risk of losing investment capital as shown above is simply accepted.

The present invention will provide the bondholder with another option, sell a futures contract 200 linked to the same industry, maturity and credit rating as the bond held. The futures contract 200 may act as a central liquidity marketplace for hedging all corporate bonds in the industry and therefore the futures contract 200 trades on a tighter bid/offer spread. Furthermore selling the future will avoid the necessity of borrowing a bond in the repo market.

In this hypothetical example, the futures contract 200 has a minimum price value 217 of $33.75 per ½ basis point and the bond at the present yield 405 has a DV01 410 of $676. With reference to FIG. 4, the hedge ratio may therefore be calculated as 676/(33.75*2) giving a hedge ratio 420 of 10.01 contracts. As the futures contract 200 trades in round numbers the bondholder will sell 10 contracts.

If the bondholder is correct in his/her prediction, bond yields rise by 40 basis points and at a yield of 3.30% p.a. the bond in question is now worth approximately 110.55% of notional, using standard yield to maturity calculations, and the bondholder will sustain a loss of $26,693. The futures contract 200 may show a profit of 27,000 (10*80*33.75) being number of contracts, number of half basis points, and minimum price value 217. Assuming that both the futures contract 200 and the bond move by the same number of basis points the resultant loss between the bond and the future is $306, which represents approximately ½ a basis point in yield of the bond (306/676), clearly a beneficial outcome for the bondholder and far better than any of the initial three options outlined above. This ‘drift’ occurs mainly due to the fact that the bond DV01 401 is not a constant like the minimum price value 217 of the futures contract 200 and that the bond DV01 401 will in fact change as the yield changes as shown in FIG. 4.

The risk to the bondholder is that the corporate bond yield being hedged moves by a different amount than the benchmark bond reference rate 201. This may happen if the perception of the riskiness of the corporation in question differs from that of the overall industry, in which case these moves may easily be greater than the loss due to the ‘drift’ on the hedge. The loss on the hedge, when taken into consideration against residual credit spread risks, cash bid/offer spreads and illiquidity is a relatively small number and therefore this loss may be disregarded as ‘noise’.

The performance of the futures contract 200 would be unacceptable to a holder of government bonds where the credit is homogeneous, the bid/offer spread on the cash bonds may be as low as 0.2 basis points and there are no liquidity concerns. Thus government bond futures need to be more complex to offer a more precise hedge. In contrast the present invention provides a computerized method for facilitating futures trading of corporate bonds which does not rely on complex considerations.

As will be understood by a person skilled in the art of futures trading, the futures contract 200 will not necessarily trade or be quoted at the same price/yield as the yield of the underlying synthetic corporate bond benchmark prior to expiry of the futures contract. Convergence is only forced in the settlement method 224 at expiry of the futures contract 200.

### Example 2

A dealer seeks to generate a profit by buying and selling bonds and capturing the bid offer spread. The dealer seeks returns commensurate with the risk involved in the activity and where markets are liquid and risk is easy to enter and exit, the bid/offer spread will be narrower than a market where liquidity is ‘thin’ and trading happens infrequently. A dealer who seeks such a return in the cash corporate bond market may have to hold a position for some time.

A dealer owning a corporate bond has limited ability to hedge credit spread risk and thus quotes a wide price, or doesn't quote at all and thus the illiquidity continues. The most obvious option for a dealer who buys a bond is simply to hold it until a buyer is located however long that may be. In the meantime the credit spread may move but hopefully the dealer has sufficient profit in the price at which he purchased the bond and this adverse move will still leave the dealer with a profit at the end of the day.

The futures contract 200 may offer the dealer a source of liquidity to hedge credit spread risk for an industry. For example, a dealer when he buys a bond issued by an investment bank may turn round and sell the futures contract 200 with a synthetic corporate bond benchmark 201 linked to the Financials industry 205. The dealer may locate a buyer for the bond a few days later, sells the bond and buys the future. The existence of the future as a liquid hedge may mean that the dealer can wait for a more advantageous price on the cash bond thus capturing more of the initial bond bid/offer spread. The ability to capture more of the spread will mean that the dealer may quote tighter prices in the first place and attract more business with less risk. As other dealers use the futures contract 200 to hedge their bond trades in the industry 205 the futures contract 200 gains liquidity and thus trades in many individual bonds become one central pool of liquidity. The role of futures contract 200 may be pivotal in providing the central source of liquidity that facilitates tighter bid/offer spreads in cash bonds. This in turn by attracting more investors to the corporate bond market may increase liquidity and lower spreads, and thereby may reduce the cost at which corporations can raise cash.

### Example 3

An investor or money manager may have various views and opinions on the potential value in one industry versus another. For example, an investor may believe that corporate bonds in the health care industry will outperform those in the financial industry and therefore he wishes to gain exposure to the difference in yield between the two industries.

One way to execute on this view at the present time is to buy bonds in the health care industry while selling those in the financial industry. A person practiced in the art of bond trading will appreciate the complexities of assembling offsetting portfolios of bonds of the same duration, bpv/dv01 and convexity, not to mention the difficulties of borrowing the bonds shorted in the repo market. Alternatives to this option may be to assemble the trade using credit default swaps or the investor may call an investment bank and enter into a tailor made transaction. However these alternatives may have liquidity implications that the investor is not willing to assume.

In another alternative in accordance with the present invention, the investor may buy a futures contract 200 with a contract synthetic corporate bond benchmark 201 linked to the healthcare industry 205, and the investor may form a view about which tenor 202, and/or rating 204 would be most advantageous to use. The ‘long position’ may be offset by selling a futures contract 200 with a synthetic corporate bond benchmark 201 linked to the financials industry 205 with a similar tenor 203 and rating 204 as the health care industry future. The minimum price movement 216 and the minimum price valuation 217 may be the same on both contracts, thus simplifying the execution of the trade i.e., the investor buys and sells the same number of contracts of each future.

A hypothetical example illustrating this embodiment of the invention is set forth below.

Given a market quoted below the investor will ‘open’ a position by buying healthcare at 96.32 and selling financials at 97.30.

| | Futures Prices | | Implied Yields p.a. | |
|---|---|---|---|---|
| Financials | 97.30 | 97.32 | 2.70 | 2.68 |
| Health Care | 96.30 | 96.32 | 3.70 | 3.68 |

At a later time the market may be quoted as below and the investor ‘closes’ the position by selling healthcare at 97.50 and buying financials at 98.02. The investor realizes a profit of $3,105 (where “bp” means basis points).

| | Prices | | Yields | |
|---|---|---|---|---|
| Financials | 98.00 | 98.02 | 2.00 | 1.98 |
| Health Care | 97.50 | 97.51 | 2.50 | 2.49 |
| Healthcare | | | | |
| | 1 | 96.32 | | |
| | −1 | 97.50 | | |
| by move 118.00* 67.50 = | | | $7,965.00 | |
| Financials | | | | |
| | −1 | 97.30 | | |
| | 1 | 98.02 | | |

| | |
|---|---|
| by move 72.00* 67.50 = | −$4,860.00 |
| Net Profit/(loss) | $3,105.00 |

While the general level of yields changed on both contracts, the investor was trading a view on the relative value and has simply and effectively captured that change by use of the futures contracts 200 on the relevant synthetic corporate bond benchmarks and has been insulated from general movement in interest rates. The constant nature of the minimum price value 217 reduces the complexities associated with attempting to replicate the same exposure in the cash corporate bond market.

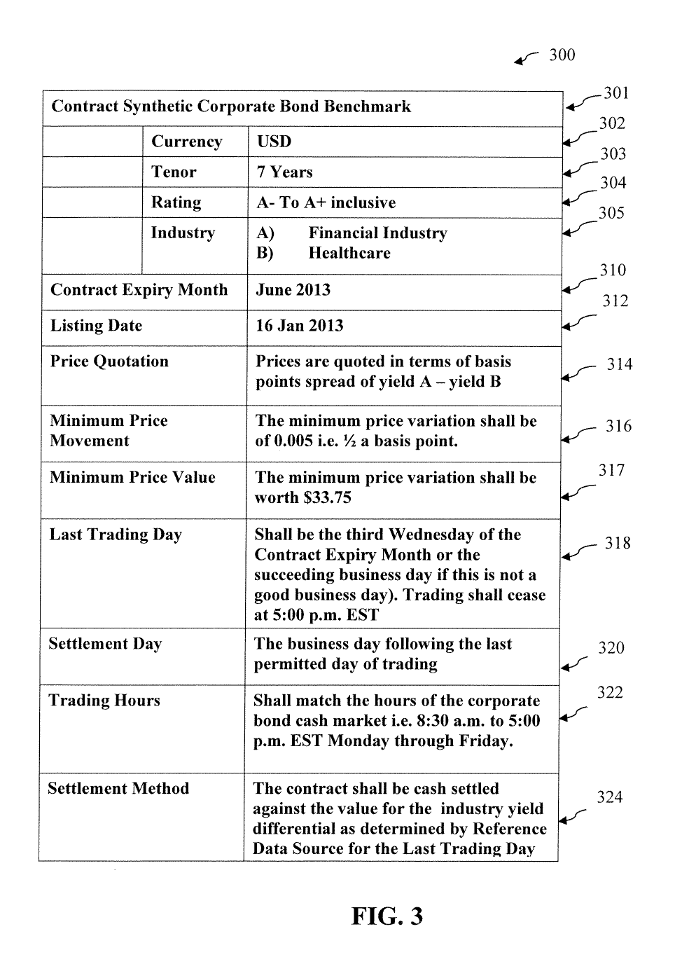

FIG. 3 illustrates another embodiment of a futures contract 200 where the contract synthetic corporate bond benchmark 301 is constructed to capture the change in the difference in yields between two individual synthetic corporate bond benchmarks linked to different industries 305. In this embodiment the minimum price movement 316 and the minimum price value 317 may be the same as the futures contracts 200 with contract synthetic corporate bond benchmarks 201 linked to individual synthetic corporate bond benchmarks or industries 205. The price quotation 314 is the number of basis points difference between the two underlying futures price quotations. In this example for the contract synthetic corporate bond benchmark 301 Financials/Healthcare Spread the price quotation 414 is 98/102.

| | Futures Prices | | Implied Yields p.a. | |
|---|---|---|---|---|
| Financials | 97.30 | 97.32 | 2.70 | 2.68 |
| Health Care | 96.30 | 96.32 | 3.70 | 3.68 |
| Spreads | | | 0.98 | 1.02 |

where buy Financials sell Health Care = 102
sell Financials buy Health Care = 98

In one embodiment a futures spread contract 300 may be settled as two individual trades. In another embodiment the futures spread contract 300 may be settled as one trade.

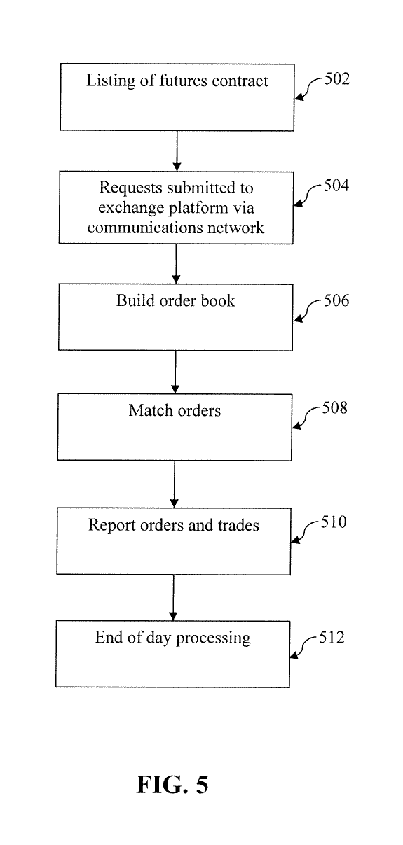

FIG. 5 depicts an overview of a simplified flow chart that illustrates a process that may be performed by a futures trading exchange using the system 100. In FIG. 5, block 502, the futures exchange lists one or more futures contracts 200 that are cash settled by the clearing house 150 relative to the settlement method 224. In further embodiments, the listing of futures contracts may (in addition to or alternatively) include spread contracts 300 and option on futures contracts 200 and 300.

In FIG. 5, block 504, the buyer 101, seller 103 and brokers 105 submit orders and requests to the exchange platform 120 via the communications network 110. The exchange platform 120 receives an order to buy one of the futures contracts listed at 502 and stored in the listing utility 124 or an order to sell one of the futures contracts listed at 502. The order may include some or all of the order parameter data detailed in the contract specification 200 or 300. On receiving the order, the exchange platform 120 may time-stamp the order and store it, including the order parameter data, and build a book of orders block 506. At FIG. 5, block 508 the matching engine and order book 128 matches buy orders with sell orders with respect to each listed futures contract 200 or 300. This may be done in accordance with conventional practices and may be ongoing during the trading day as orders are received

At 510 in FIG. 5, the exchange platform 120 provides reports of trades executed and orders placed in the order book(s) for the listed futures contract(s). This reporting may, among other functions, be disseminated to market participants and data vendors by the data dissemination processor 130 and become a source of market quotations for potential traders. Moreover, the reporting may be such as required to comply with regulatory policies and the internal requirements of the futures trading exchange.

At 512 in FIG. 5, the exchange platform 120 performs conventional functions required for overnight processing and to facilitate settlement of trades executed during the trading day.

As one skilled in the art will appreciate embodiments of the invention provide many desirable and beneficial features, including but not limited to:
(1) the invention provides that futures contract shall be cash settled avoiding the necessity of physical delivery and concerns about liquidity and availability of cheapest to deliver corporate bonds,
(2) the invention provides a simple calculation of profit and loss arising from a position by assigning a constant currency value to a minimum incremental change in yield,
(3) the invention provides a clear and easy method to ascertain the yield being traded by quoting the price terms of the contract as 100 minus yield,
(4) the invention provides a novel method of trading and hedging portfolios of corporate bonds,
(5) the invention offers investors an instrument to trade which is a combination of both credit spread and risk free rate exposure in one contract,
(6) the invention offers an investor an instrument to trade the relative yields of one industry versus another through the combination of two futures contracts, or in another embodiment the trading of such relative yields through the offering of one contract linked to the yield differential,
(7) the invention offers an investor an instrument to trade the yield curve within an industry by the combination of two futures contracts,
(8) the invention offers an investor an instrument to trade an option on the futures contact,
(9) the invention will facilitate increased liquidity and tighter bid/offer spreads in the corporate bond cash market by the creation of a liquid hedge instrument, and
(10) the invention will provide wider access to the corporate bond market through the establishment of a standardized exchange traded instrument linked to the performance of a synthetic corporate bond benchmark.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

What is claimed is:

1. A computerized method for operating an exchange facilitating the trading of a futures contract for at least one synthetic corporate bond benchmark, the method comprising the following steps:
(a) listing a futures contract for at least one synthetic corporate bond benchmark on an exchange platform, the futures contract including an initial traded price for the at least one synthetic corporate bond benchmark, terms for settlement including a minimum price increment, and an expiry date, wherein terms for settlement require a settlement value which is a cash payment from one party to another based upon at least one synthetic corporate bond benchmark yield,
(b) receiving, by electronic transmission, one or more orders to buy or sell the futures contract for at least one synthetic corporate bond benchmark,
(c) matching the orders via a computer process according to pre-defined matching rules and maintaining a book of pending orders,
(d) receiving by electronic transmission at least one synthetic corporate bond benchmark yield, and
(e) determining, using a computer processor included in the exchange platform, a settlement value for the futures contract.

2. A computerized method according to claim 1 further comprising electronically transmitting the settlement value to a clearing house, wherein the clearing house cash settles the futures contract.

3. A computerized method according to claim 1 further comprising electronically transmitting information including the initial traded price, quantity of contracts and time of executed orders, pending orders and final settlement price to a platform which can be accessed by recipients interested in participating in buying or selling the synthetic corporate bond benchmark futures.

4. A computerized method according to claim 1 wherein the least one synthetic corporate bond benchmark yield is obtained from the Bloomberg Valuation Service.

5. A computerized method according to claim 1 wherein settlement terms include a minimum price increment value which is a constant value that does not vary throughout the life of the futures contract.

6. A computerized method according to claim 1 for a futures contract for at least two synthetic corporate bond benchmarks wherein terms for settlement require a settlement value which is a cash payment from one party to another based upon a first synthetic corporate bond benchmark yield and a second synthetic corporate bond benchmark yield.

7. A computerized method according to claim 6 wherein the first synthetic benchmark rate is a synthetic corporate bond benchmark yield for a first industry and the second synthetic corporate bond benchmark yield is a synthetic corporate bond benchmark rate for an industry which is different from the first industry.

8. A computerized method according to claim 5 wherein the amount of the cash payment is determined as the difference between the initial traded price and a final settlement price multiplied by the number of minimum price increments included in the difference multiplied by the minimum price increment value.
